(19) United States
(12) Patent Application Publication
(10) Pub. No.: US 2024/0241214 A1
(43) Pub. Date: Jul. 18, 2024

(54) Control Signaling for Monostatic Radar Sensing

(71) Applicant: Google LLC, Mountain View, CA (US)

(72) Inventors: Jibing Wang, San Jose, CA (US); Erik Richard Stauffer, Sunnyvale, CA (US)

(73) Assignee: Google LLC, Mountain View, CA (US)

(21) Appl. No.: 18/559,210

(22) PCT Filed: May 5, 2022
(86) PCT No.: PCT/US2022/072145

§ 371 Date: Nov. 6, 2023

Related U.S. Application Data
(60) Provisional application No. 63/187,778, filed on May 12, 2021.

(51) Int. Cl. G01S 7/00; G01S 13/86; H04W 8/24

(52) U.S. Cl. CPC G01S 7/006; G01S 13/86; H04W 8/24

(57) ABSTRACT

Techniques and apparatuses are described that implement control signaling for monostatic radar sensing. In particular, a base station uses control signaling to configure a user equipment for monostatic radar sensing and control when monostatic radar sensing is performed by the user equipment. With control signaling, the base station can enable monostatic radar sensing to occur using similar frequency resources used for wireless communication, which enables efficient use of a frequency spectrum. The base station can also use control signaling to reduce interference observed by other user equipment as the user equipment performs monostatic radar sensing. By performing monostatic radar sensing, the user equipment compiles explicit information about objects within an operating environment and shares this information with the base station. The base station uses this information to improve wireless communication performance.

### BACKGROUND

Evolving wireless communication systems utilize increasingly complex architectures as a way to provide more performance relative to preceding wireless communication systems. As one example, fifth generation new radio (5G NR) wireless technologies transmit data using higher frequency ranges, such as the above-6 gigahertz (GHz) band or the terahertz (Thz) band, to increase data capacity. However, transmitting and recovering information using these higher frequency ranges poses challenges. To illustrate, higher-frequency signals are more susceptible to multipath fading, scattering, atmospheric absorption, diffraction, and interference, relative to lower frequency signals.

### SUMMARY

Techniques and apparatuses are described that implement control signaling for monostatic radar sensing. In particular, a user equipment can operate as a monostatic radar using an integrated radar sensor or circuitry that supports both monostatic radar sensing and wireless communication. A base station uses control signaling to configure the user equipment for monostatic radar sensing and control signaling when monostatic radar sensing is performed by the user equipment. With control signaling, the base station can enable monostatic radar sensing to occur using similar frequency resources used for wireless communication, which enables efficient use of a frequency spectrum. Additionally, by using the same frequency resources, the monostatic radar sensing can provide explicit information about a transmission channel as opposed to more generalized information about a behavior of the transmission channel. The base station can also use control signaling to reduce interference observed by other user equipment as the user equipment performs monostatic radar sensing. By performing monostatic radar sensing, the user equipment compiles explicit information about objects within an operating environment and shares this information with the base station. The base station uses this information to improve wireless communication performance.

In aspects, a user equipment transmits a radar capability message to a base station. The radar capability message includes at least one available configuration of the user equipment for monostatic radar sensing. The user equipment also receives a radar configuration message from the base station. The radar configuration message directs the user equipment to use a particular configuration for monostatic radar sensing. The user equipment additionally receives a radar request message from the base station. The radar request message requests that the user equipment performs monostatic radar sensing. Responsive to receiving the radar request message, the user equipment transmits a radar signal using the particular configuration.

In aspects, a base station receives a radar capability message from a user equipment. The radar capability message includes at least one available configuration of the user equipment for monostatic radar sensing. The base station also transmits a radar configuration message to the user equipment. The radar configuration message directs the user equipment to use a particular configuration for monostatic radar sensing. The base station further transmits a radar request message to the user equipment. The radar request message requests that the user equipment transmits a radar signal using the particular configuration.

Aspects described below also include a system with means for control signaling to enable monostatic radar sensing.

### BRIEF DESCRIPTION OF DRAWINGS

Apparatuses for and techniques implementing control signaling for monostatic radar sensing are described with reference to the following drawings. The same numbers are used throughout the drawings to reference like features and components:

FIG. 1 illustrates example environments in which various aspects of control signaling for monostatic radar sensing can be implemented:

FIG. 2 illustrates an example environment in which various aspects of control signaling for monostatic radar sensing can be implemented:

FIG. 3 illustrates example signals for monostatic radar sensing:

FIG. 4 illustrates an example device diagram of devices that can implement various aspects of control signaling for monostatic radar sensing:

FIG. 5 illustrates an example block diagram of a wireless network stack model in which various aspects of control signaling for monostatic radar sensing can be implemented:

FIG. 6 illustrates an example transaction diagram between various network entities that implement control signaling for monostatic radar sensing:

FIG. 7 illustrates an example method for performing operations of control signaling for monostatic radar sensing: and

FIG. 8 illustrates another example method for performing operations of control signaling for monostatic radar sensing.

### DETAILED DESCRIPTION

### Overview

Channel estimation techniques can improve wireless communication performance in the presence of challenging environmental conditions described in the Background section. For example, a base station and user equipment can use channel estimation to determine beamforming configurations that increase signal-to-noise ratios. Channel estimation techniques, however, provide information about the operating environment in an indirect, composite manner. Consequently, direct (e.g., explicit) information about the operating environment (e.g., information about objects within the environment) are still unknown.

In contrast, techniques for control signaling for monostatic radar sensing are described herein. A user equipment can operate as a monostatic radar using an integrated radar sensor or circuitry that supports both monostatic radar sensing and wireless communication. A base station uses control signaling to configure the user equipment for monostatic radar sensing and control when monostatic radar sensing is performed by the user equipment. With control signaling, the base station can enable monostatic radar sensing to occur using similar frequency resources used for wireless communication, which enables efficient use of a frequency spectrum. Additionally, by using the same frequency resources, the monostatic radar sensing can provide explicit information about a transmission channel as opposed to more generalized information about a behavior of the transmission channel. The base station can also use control signaling to reduce interference observed by other user equipment as the user equipment performs monostatic radar sensing. By performing monostatic radar sensing, the user equipment compiles explicit information about objects within an operating environment and shares this information with the base station. The base station uses this information to improve wireless communication performance.

### Example Environment

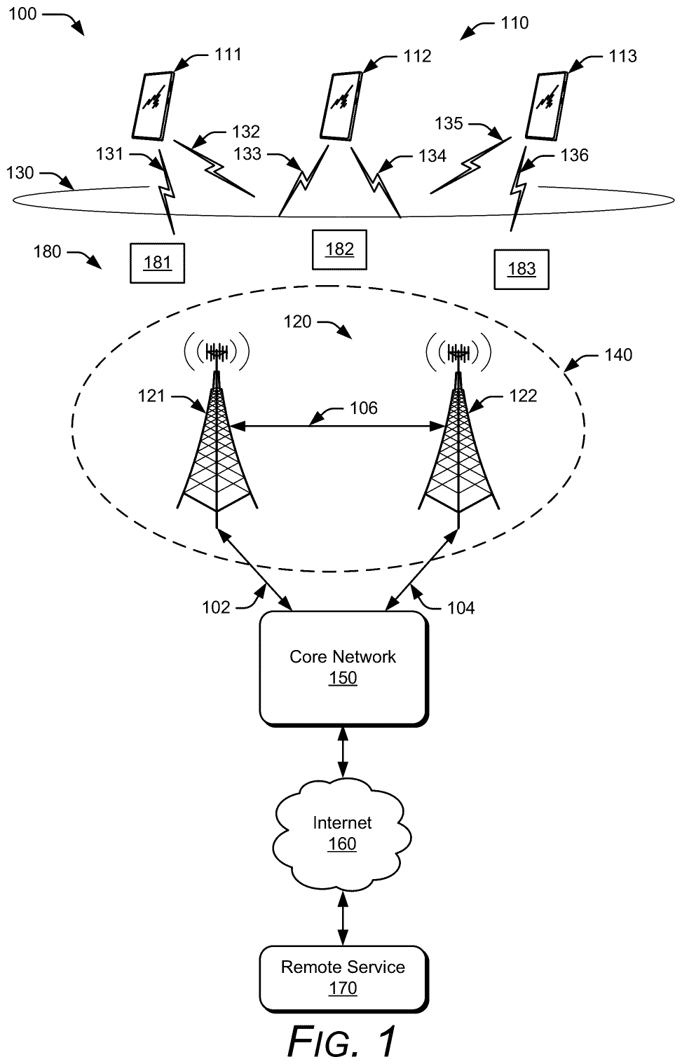

FIG. 1 illustrates an example environment 100, which includes multiple user equipment 110 (UE 110), illustrated as UE 111, UE 112, and UE 113. Each user equipment 110 can communicate with one or more base stations 120 (illustrated as base stations 121 and 122) through one or more wireless communication links 130 (wireless link 130), illustrated as wireless link 131, wireless link 132, wireless link 133, wireless link 134, wireless link 135, and wireless link 136. For simplicity, the user equipment 110 is implemented as a smartphone but may be implemented as any suitable computing or electronic device, such as a mobile communication device, modem, cellular phone, gaming device, navigation device, media device, laptop computer, desktop computer, tablet computer, smart appliance, vehicle-based communication system, or an Internet-of-Things (IoT) device such as a sensor or an actuator. The base stations 120 (e.g., an Evolved Universal Terrestrial Radio Access Network Node B, E-UTRAN Node B, evolved Node B, eNodeB, eNB, Next Generation Node B, gNode B, gNB, ng-eNB, or the like) may be implemented in a macrocell, microcell, small cell, picocell, distributed base station, and the like, or any combination thereof.

The base stations 120 communicate with the user equipment 110 using the wireless links 130, which may be implemented as any suitable type of wireless link. The wireless links 130 include control and data communication, such as downlink of data and control information communicated from the base stations 120 to the user equipment 110, uplink of other data and control information communicated from the user equipment 110 to the base stations 120, or both. The wireless links 130 may include one or more wireless links (e.g., radio links) or bearers implemented using any suitable communication protocol or standard, or combination of communication protocols or standards, such as Third Generation Partnership Project Long-Term Evolution (3GPP LTE), Fifth Generation New Radio (5G NR), and future evolutions. Multiple wireless links 130 may be aggregated in a carrier aggregation or multi-connectivity technology to provide a higher data rate for the user equipment 110. Multiple wireless links 130 from multiple base stations 120 may be configured for Coordinated Multipoint (COMP) communication with the user equipment 110. Additionally, multiple wireless links 130 may be configured for single-radio access technology (RAT) (single-RAT), dual connectivity (single-RAT-DC), or multi-RAT dual connectivity (MR-DC). The wireless links 130 may be affected by permanent or temporary channel impairments such as buildings, foliage, precipitation, and other moving or stationary objects 180, illustrated as objects 181, 182, and 183.

The base stations 120 are collectively a Radio Access Network 140 (e.g., RAN, Evolved Universal Terrestrial Radio Access Network, E-UTRAN, 5G NR RAN or NR RAN). The base stations 121 and 122 in the RAN 140 are connected to a core network 150. The base stations 121 and 122 connect, at interface 102 and interface 104 respectively, to the core network 150 through an NG2 interface for control-plane signaling and using an NG3 interface for user-plane data communications when connecting to a 5G core network, or using an SI interface for control-plane signaling and user-plane data communications when connecting to an Evolved Packet Core (EPC) network. The base stations 121 and 122 can communicate using an Xn Application Protocol (XnAP) through an Xn interface, or using an X2 Application Protocol (X2AP) through an X2 interface, at interface 106, to exchange user-plane and control-plane data.

The user equipment 110 may connect, via the core network 150, to public networks, such as the Internet 160 to interact with a remote service 170. The remote service 170 represents the computing, communication, and storage devices used to provide any of a multitude of services including interactive voice or video communication, file transfer, streaming voice or video, and other technical services implemented in any manner such as voice calls, video calls, website access, messaging services (e.g., text messaging or multi-media messaging), photo file transfer, enterprise software applications, social media applications, video gaming, streaming video services, and podcasts.

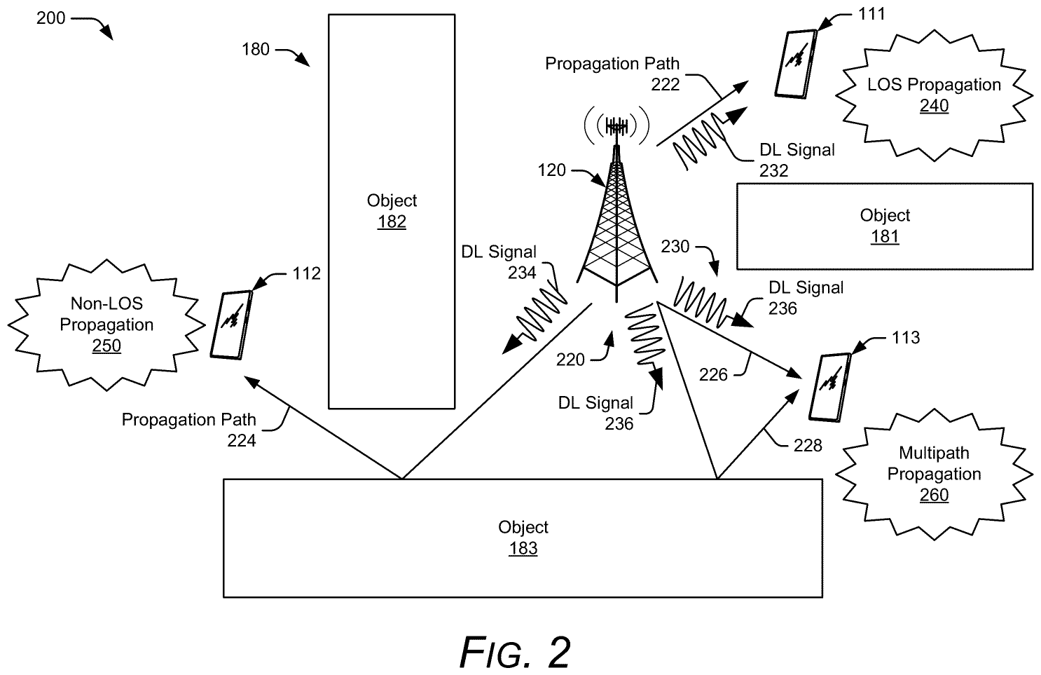

FIG. 2 illustrates an example environment 200 that includes multiple objects 180 between the base station 120 and the UEs 111, 112, and 113. The multiple objects 180 are illustrated as objects 181, 182, and 183. The objects 180 can be stationary or moving. Example stationary objects include buildings, tunnels, bridges, rocks, plants, walls of a room, panes of glass, and furniture. Example moving objects include humans, animals, water vapor, precipitation, and vehicles.

Sometimes the existence and position of the objects 180 within the environment 200 can make it challenging for the base station 120 and the user equipment 111, 112, and 113 to communicate. For example, the objects 180 can cause a wireless communication signal to reflect, diffract, or scatter, which results in the wireless communication signal propagating across multiple propagation paths 220. Sample multiple propagation paths 220 of an omnidirectional signal from the base station 120 include propagation paths 222, 224, 226, and 228. The multiple propagation paths 220 can cause multiple delayed versions of the wireless communication signal to reach a receiving entity at different times. This can cause the received wireless communication signal to become distorted (e.g., due to intersymbol interference (ISI)) or have a smaller signal-to-noise ratio. As another example, an object 180 prevents the base station 120 and the user equipment 110 from having direct line-of-sight communication. As shown in FIG. 2, for instance, the object 182 obstructs the line-of-sight communication between the user equipment 112 and the base station 120.

The techniques for control signaling enable the base station 120 to configure the user equipment 111, 112, and 113 for monostatic radar sensing. Through monostatic radar sensing, the user equipment 111, 112, and 113 directly measure explicit information about the objects 180 within the current environment 200. This information can include position information (e.g., distance and/or angles), movement information (e.g., Doppler velocity and/or total velocity), size information (e.g., width, length, and/or height), material composition information (e.g., reflection coefficient and/or radar cross section), or some combination thereof. With this information, the base station 120 can determine the propagation environment (e.g., estimate the propagation paths 220) and customize operations to improve wireless communication performance.

For example, the base station 120 tailors its beamforming configurations based on the determined propagation environment to facilitate communications with the user equipment 111, 112, and 113. Additionally or alternatively, the base station 120 directs the user equipment 111, 112, and 113 to utilize particular beamforming configurations. The base station 120 can also direct the user equipment 111, 112, and 113 to utilize customized schedules for transmission and reception (e.g., for beam management). These beamforming configurations can be designed to increase a signal-to-noise ratio at a receiving entity and/or reduce interference. Based on the measured movement of the objects 180, the base station 120 can predict changes in the environment 200 and dynamically adjust the beamforming configurations. In this way, the base station 120 proactively plans wireless communications based on knowledge of the environment 200 obtained using monostatic radar sensing. Also, the base station 120 can use its knowledge of the propagation environment to cancel received interference from other known propagation paths. This can further improve the signal-to-noise ratio at the base station 120.

Consider an example in which the base station 120 customizes transmission of downlink signals 230 (DL signals 230), illustrated as downlink signals 232, 234, and 236, based on knowledge of the environment 200. To transmit the downlink signal 232 to the user equipment 111, the base station 120 takes advantage of line-of-sight propagation 240. In this case, the base station 120 uses a beamforming configuration to cause the downlink signal 232 to traverse propagation path 222, which is a direct line-of-sight path between the base station 120 and the user equipment 111. An example beamforming configuration produces a radiation pattern with a main lobe that has a narrow beamwidth and is steered along an angle associated with the propagation path 222. By using a narrow beamwidth and steering the main lobe towards the user equipment 111, the base station 120 can reduce losses associated with propagation, reflection, and multipath fading. In this way, the base station 120 can improve wireless communication performance.

To transmit the downlink signal 234 to the user equipment 112, the base station 120 uses non-line-of-sight (non-LOS) propagation 250. In particular, the base station 120 uses another beamforming configuration to cause the downlink signal 234 to traverse a propagation path 224 and reflect off the object 183 towards the user equipment 112. In this way, the downlink signal 234 travels around the object 182. By using the propagation path 224, the base station 120 can overcome the challenges associated with the object 182 obstructing the line-of-sight communication between the base station 120 and the user equipment 112.

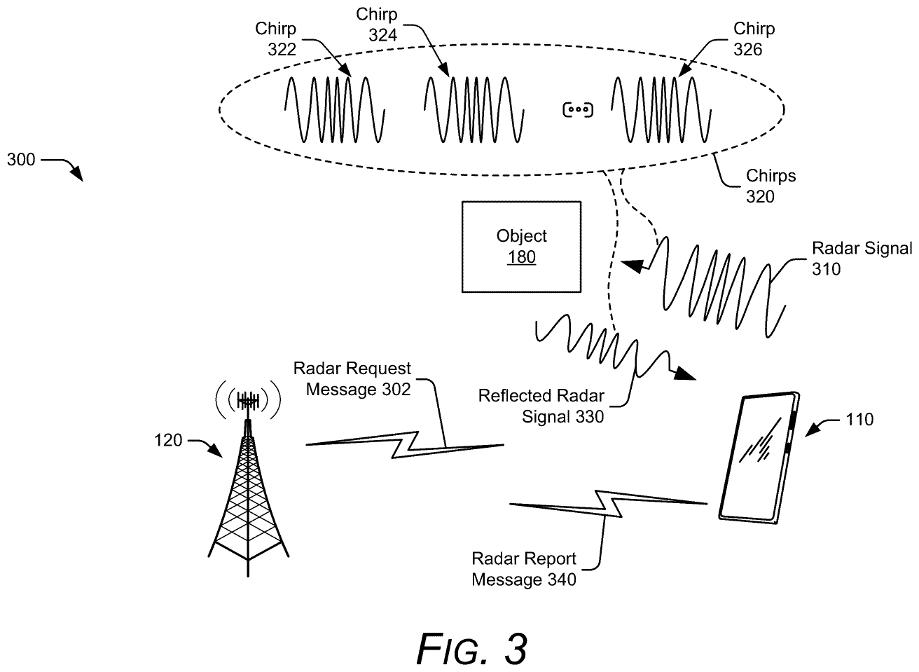

To transmit the downlink signal 236 to the user equipment 113, the base station 120 uses multipath propagation 260. In this case, the downlink signal 236 travels along propagation paths 226 and 228. The propagation path 226 is a direct path along a line-of-sight between the base station 120 and the user equipment 113. In contrast, the propagation path 228 is an indirect path, which causes the downlink signal 236 to reflect off of the object 183 towards the user equipment 113. The base station 120 can utilize the multipath propagation 260 to improve a signal-to-noise ratio at the user equipment 113 and/or increase channel capacity with MIMO techniques. In general, the base station 120 performs channel planning using direct knowledge about the objects 180, which is obtained from radar data provided by the user equipment 110. Operations of the user equipment 110 for monostatic radar sensing are further described with respect to FIG. 3.

FIG. 3 illustrates example signals for monostatic radar sensing. In an example environment 300, the user equipment 110 operates as a monostatic radar to detect the object 180. In this example, the user equipment 110 implements a frequency-modulated continuous-wave radar. However, other types of radars are also possible, including a pulse-Doppler radar, a phase-modulated spread-spectrum radar, an impulse radar, a radar that uses Zadoff-Chu sequences or constant-amplitude zero-autocorrelation (CAZAC) sequences, or a MIMO radar.

To initiate monostatic radar sensing, the base station 120 transmits a radar request message 302 to the user equipment 110. The radar request message 302 requests that the user equipment 110 perform monostatic radar sensing. The radar request message 302 can include limitations, such as a time constraint. For example, the radar request message 302 instructs the user equipment 110 to perform monostatic radar sensing for a specified time interval.

During monostatic radar sensing, the user equipment 110 transmits a radar signal 310. The radar signal 310 in this example represents a frequency-modulated signal. In other implementations, the radar signal 310 can include a pulsed signal or a phase-modulated signal. The example radar signal 310 includes a sequence of chirps 320, illustrated as chirps 322, 324, and 326. The chirps 320 can be transmitted in a continuous burst or separated in time. The multiple chirps 320 enable the user equipment 110 to make multiple observations of the object 180 over a predetermined time period.

Frequencies of the chirps 320 can increase or decrease over time. In the depicted example, the user equipment 110 employs a two-slope cycle (e.g., triangular frequency modulation) to linearly increase and linearly decrease the frequency of each chirp 320 over time. The two-slope cycle enables the user equipment 110 to measure the Doppler frequency shift caused by motion of the object 180. In general, the user equipment 110 tailors transmission characteristics of the chirps 320 (e.g., bandwidth, center frequency, duration, and transmit power) to achieve a particular detection range, range resolution, or doppler sensitivity for detecting the object 180.

The radar signal 310 propagates through space and reflects off the object 180. A reflected version of the radar signal 310 is represented by reflected radar signal 330. The reflected radar signal 330 propagates back towards the user equipment 110. Similar to the radar signal 310, the reflected radar signal 330 is composed of the chirps 320. As depicted in FIG. 3, an amplitude of the reflected radar signal 330 is smaller than an amplitude of the radar signal 310 due to losses incurred during propagation and reflection.

For monostatic radar sensing, the user equipment 110 receives the reflected radar signal 330 and process the reflected radar signal 330 to detect the object 180. At the user equipment 110, the reflected radar signal 330 represents a delayed, attenuated version of the radar signal 310. The amount of delay is proportional to a distance between the user equipment 110 and the object 180. In particular, this delay represents a summation of a time it takes for the radar signal 310 to propagate from the user equipment 110 to the object 180 and a time it takes for the reflected radar signal 330 to propagate from the object 180 to the user equipment 110. If the object 180 or the user equipment 110 is moving, the reflected radar signal 330 is shifted in frequency relative to the radar signal 310 due to the Doppler effect. In other words, certain characteristics of the reflected radar signal 330 are dependent upon motion of the object 180 and motion of the user equipment 110.

The user equipment 110 analyzes the reflected radar signal 330 to detect the object 180 and determine explicit information about the object 180. The explicit information includes position information (e.g., distance or angle), movement information (e.g., Doppler frequency or total velocity), size information (e.g., length, width, or height), and/or material or surface composition information (e.g., a reflection coefficient or radar cross section) of the object 180.

The user equipment 110 transmits a radar report message 340 to communicate information about the object 180 to the base station 120. By compiling information about the object 180 from one or more user equipment 110, the base station 120 can obtain knowledge about a current operating environment, such as the environment 200 shown in FIG. 2. With this knowledge, the base station 120 can map the environment, determine available propagation paths 220, and customize operations for wireless communication accordingly.

The general concept of control signaling for monostatic radar sensing can be applied to multiple user equipment 110 (e.g., user equipment 111, 112, and 113). In some situations, the base station 120 configures multiple user equipment 110 for monostatic radar sensing to utilize triangulation techniques and determine an angular position of the object 180. This can be advantageous in situations in which the multiple user equipment 110 respectively receive the reflected radar signal 330 using a single antenna. The base station 120 can combine the information provided by the multiple user equipment 110 to obtain a more accurate estimate of the environment.

### Example Devices

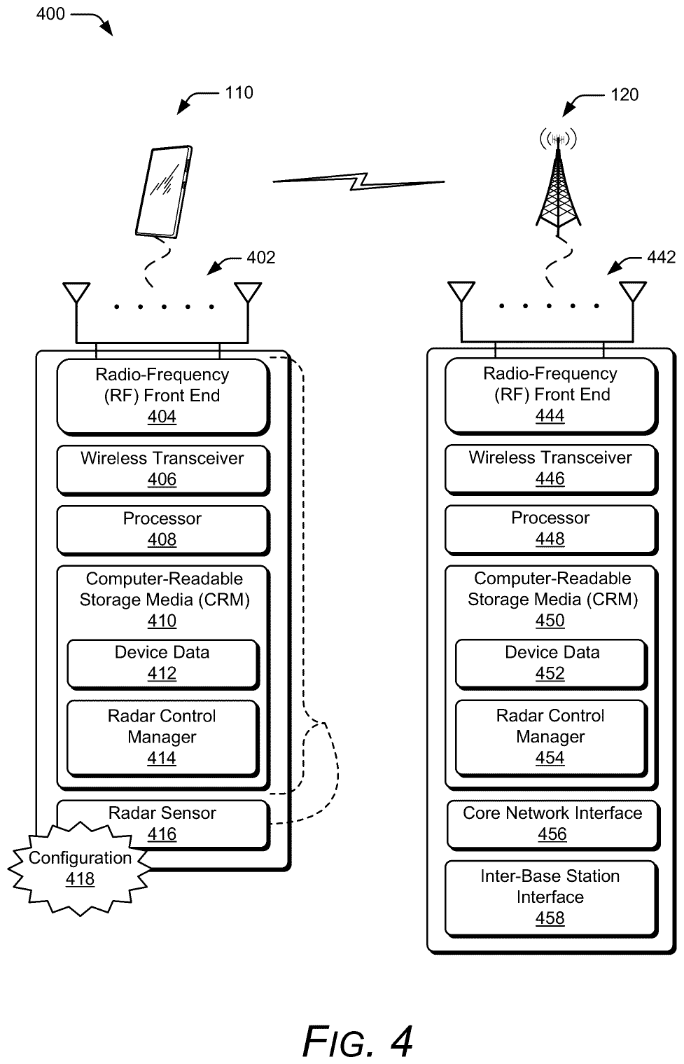

FIG. 4 illustrates an example device diagram 400 of the user equipment 110 and the base station 120 that can implement various aspects of control signaling for monostatic radar sensing. The user equipment 110 and the base station 120 can include additional functions and interfaces that are omitted from FIG. 4 for the sake of clarity.

The user equipment 110 includes antennas 402, a radio-frequency front end 404 (RF front end 404), and a wireless transceiver 406 (e.g., an LTE transceiver and/or a 5G NR transceiver). The antennas 402, the radio-frequency front end 404, and the wireless transceiver 406 can be used for communicating with the base station 120 in the RAN 140. The radio-frequency front end 404 couples or connects the wireless transceiver 406 to the antennas 402. The antennas 402 can include an array of multiple antennas that are configured similar to or differently from each other. The antennas 402 and the radio-frequency front end 404 can be tuned to, and/or be tunable to, one or more frequency bands defined by the 3GPP LTE and 5G NR communication standards and implemented by the wireless transceiver 406. By way of example and not limitation, the antennas 402 and the radio-frequency front end 404 can be implemented for operation in sub-GHz bands, sub-6 GHz bands, and/or above 6 GHz bands (e.g., GHz bands associated with millimeter wavelengths or terahertz (THz) bands associated with sub-millimeter wavelengths). Additionally, the antennas 402, the radio-frequency front end 404, and the wireless transceiver 406 may be configured to support beamforming for wireless communication.

The user equipment 110 also includes at least one processor 408 and at least one computer-readable storage media 410 (CRM 410). The processor 408 may be a single core processor or a multiple core processor composed of a variety of materials, such as silicon, polysilicon, high-K dielectric, copper, and so on. The CRM 410 described herein excludes propagating signals and can include any suitable memory or storage device such as random-access memory (RAM), static RAM (SRAM), dynamic RAM (DRAM), non-volatile RAM (NVRAM), read-only memory (ROM), or Flash memory useable to store device data 412 of the user equipment 110. The device data 412 includes user data, multimedia data, beamforming codebooks, applications, neural network (NN) tables, neural network training data, and/or an operating system of the user equipment 110, some of which are executable by processor(s) 408 to enable user-plane data, control-plane information, and user interaction with the user equipment 110.

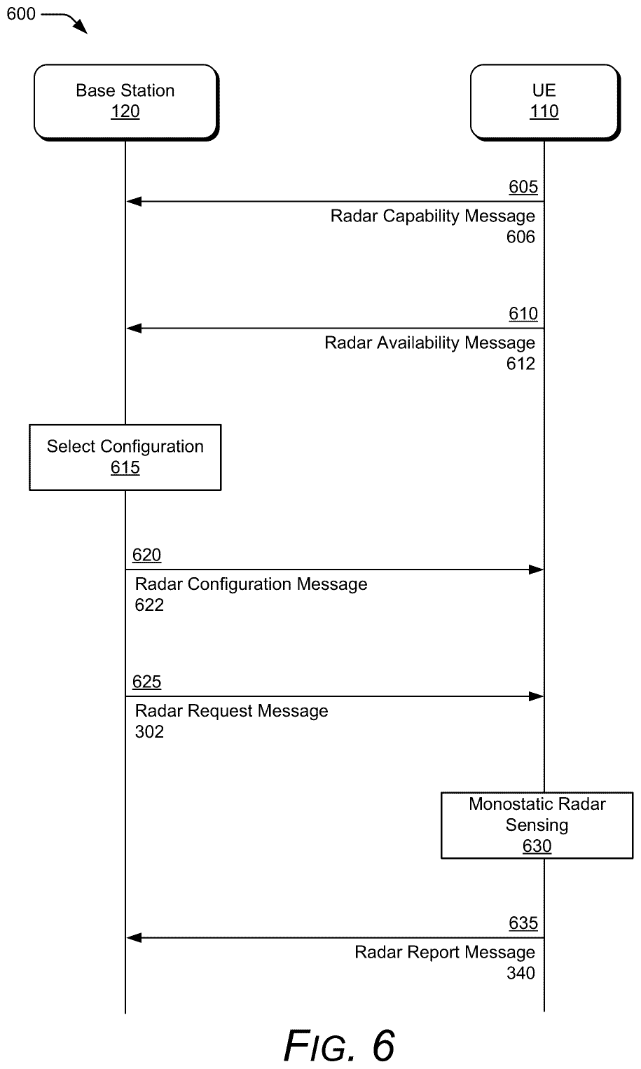

In aspects, the CRM 410 includes a radar control manager 414. Alternatively or additionally, the radar control manager 414 can be implemented in whole or part as hardware logic or circuitry integrated with or separate from other components of the user equipment 110. The radar control manager 414 processes control signaling messages, such as the radar request message 302, and generates response messages, such as the radar report message 340. These messages are further described with respect to FIG. 6. The radar control manager 414 also configures a radar sensor 416 of the user equipment 110.

In one implementation, the radar sensor 416 includes circuitry that is dedicated for monostatic radar sensing (e.g., an integrated radar sensor). In this case, the radar sensor 416 includes other antennas that are distinct from (e.g., separate from or different than) the antennas 402, another radio-frequency front end that is distinct from the radio-frequency front end 404, another wireless transceiver that is distinct from the wireless transceiver 406, another processor that is distinct from the processor 408, and another computer-readable storage media that is distinct from the computer-readable storage media 410. In some cases, the other antennas, the other radio-frequency front end, and the other wireless transceiver are implemented on an integrated circuit.

In an alternative implementation, the radar sensor 416 includes circuitry that supports both monostatic radar sensing and wireless communication. For example, the radar sensor 416 is implemented using the antennas 402, the radio-frequency front end 404, the wireless transceiver 406, the processor 408, and the computer-readable storage media 410 of FIG. 4. As described above, these components can be used for wireless communication (e.g., for transmitting uplink signals and receiving downlink signals 230). In this case, however, these components can also be used for monostatic radar sensing. For example, the processor 408 can generate a digital version of the radar signal 310 and the wireless transceiver 406 and the radio-frequency front end 404 can condition this signal for transmission using the antennas 402. In some cases, the processor 408 can implement one or more deep neural networks, which generate the digital version of the radar signal 310 and generate a digital version of an uplink signal. For reception, the antennas 402 receive the reflected radar signal 330, the radio-frequency front end 404 and the wireless transceiver 406 further condition this signal for reception, and the processor 408 employs radar signal processing techniques to process the reflected radar signal 330 and process a downlink signal 230.

In other implementations, the radar sensor 416 includes a combination of dedicated circuitry for monostatic radar sensing and shared circuitry used for both monostatic radar sensing and wireless communication. For example, the shared circuitry of the radar sensor 416 can include the computer-readable storage media 410 and the processor 408. In this case, the shared circuitry can generate baseband versions of a transmitted radar signal and process baseband versions of a received radar signal. The dedicated circuitry of the radar sensor 416 can include an integrated circuit, which includes the other antennas, the other radio-frequency front end, and the other wireless transceiver. The dedicated circuitry enables both transmission and reception of radar signals.

Sometimes the radar sensor 416 can operate according to a variety of different configurations 418. In some cases, these configurations 418 are derived from fixed limitations of the user equipment 110. These fixed limitations can be based on hardware limitations associated with the radar sensor 416 (e.g., associated with the antennas 402, the radio-frequency front end 404, the wireless transceiver 406, and/or the processor 408). Example fixed limitations include possible frequency bands, bandwidths, transmit power levels, antenna configurations, and duplex configurations the user equipment 110 is capable of employing. The configurations 418 can also be subject to limitations that can dynamically change over time. Example dynamic limitations include an amount of available power (e.g., a battery level of the user equipment 110), an amount of available memory (e.g., a size of the computer-readable storage media 410), and/or an amount of processing capacity (e.g., a processing capacity of the processor 408).

The device diagram for the base station 120, shown in FIG. 4, includes a single network node (e.g., a gNode B). The functionality of the base station 120 may be distributed across multiple network nodes or devices and may be distributed in any fashion suitable to perform the functions described herein. The base station 120 includes antennas 442, at least one radio-frequency front end 444 (RF front end 444), and one or more wireless transceivers 446 (e.g. one or more LTE transceivers and/or one or more 5G NR transceivers). The antennas 442, the radio-frequency front end 444, and the wireless transceiver 446 can be used for communicating with the user equipment 110. The radio-frequency front end 444 couples or connects the wireless transceiver 446 to the antennas 442. The antennas 442 can include an array of multiple antennas that are configured similar to, or different from, each other. The antennas 442 and the radio-frequency front end 444 can be tuned to, and/or be tunable to, one or more frequency bands defined by the 3GPP LTE and 5G NR communication standards, and implemented by the wireless transceiver 446. By way of example and not limitation, the antennas 442 and the radio-frequency front end 444 can be implemented for operation in sub-GHz bands, sub-6 GHZ bands, and/or above 6 GHz bands (e.g., GHz bands associated with millimeter wavelengths or terahertz (THz) bands associated with sub-millimeter wavelengths). Additionally, the antennas 442, the radio-frequency front end 444, and/or the wireless transceiver 446 can be configured to support beamforming, such as Massive-MIMO, for wireless communication.

The base station 120 also includes at least one processor 448 and at least one computer-readable storage media 450 (CRM 450). The processor 448 may be a single core processor or a multiple core processor composed of a variety of materials, such as silicon, polysilicon, high-K dielectric, copper, and so on. CRM 450 may include any suitable memory or storage device such as random-access memory (RAM), static RAM (SRAM), dynamic RAM (DRAM), non-volatile RAM (NVRAM), read-only memory (ROM), or Flash memory useable to store device data 452 of the base station 120. The device data 452 includes network scheduling data, radio resource management data, beamforming codebooks, applications, and/or an operating system of the base station 120, which are executable by processor 448 to enable wireless communication with the user equipment 110.

The CRM 450 includes a radar control manager 454. Alternatively or additionally, the radar control manager 454 can be implemented in whole or part as hardware logic or circuitry integrated with or separate from other components of the base station 120. The radar control manager 454 generates control signaling messages, such as the radar request message 302, and processes response messages, such as the radar report message 340. These messages are further described with respect to FIG. 6. The radar control manager 454 (or another module not shown) can process the radar report message 340 provided by the user equipment 110 and improve wireless communication performance based on information provided by this message.

The base station 120 also includes a core network interface 456, which the base station 120 configures to exchange user-plane data, control-plane information, and/or other data/information with core network functions and/or entities. The base station 120 additionally includes an inter-base station interface 458, such as an Xn and/or X2 interface, which the base station 120 configures to exchange user-plane data, control-plane information, and/or other data/information between other base stations, to manage the communication of the base station 120 with the user equipment 110.

### User Plane and Control Plane Signaling

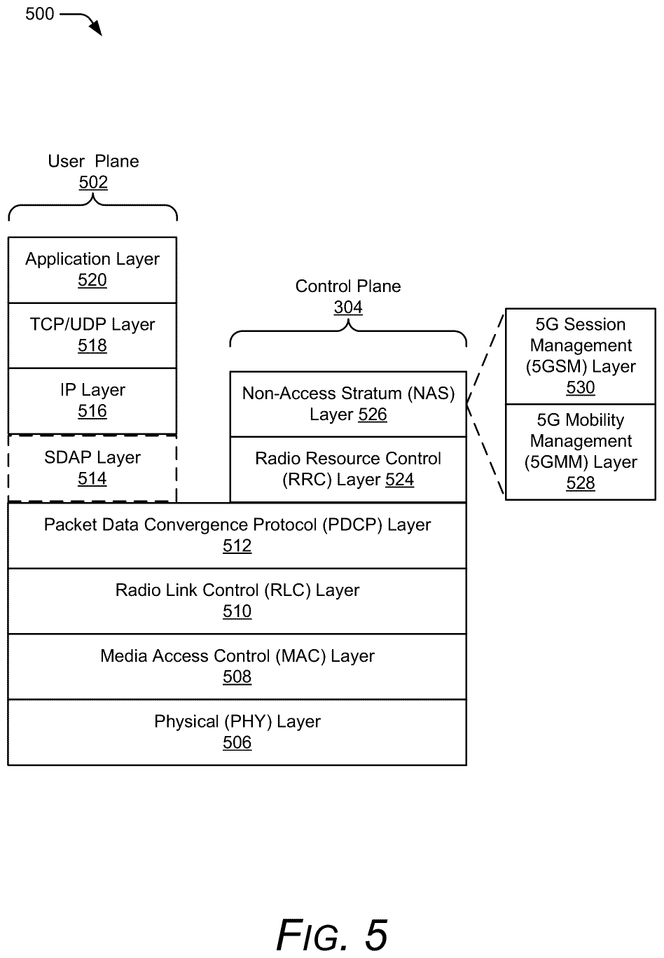

FIG. 5 illustrates an example block diagram of a wireless network stack model 500 (stack 500, network stack 500). The network stack 500 characterizes a communication system for the example environment 100, in which various aspects of control signaling for monostatic radar sensing can be implemented. The network stack 500 includes a user plane 502 and a control plane 504. Upper layers of the user plane 502 and the control plane 504 share common lower layers in the network stack 500. Wireless devices, such as the user equipment 110 or the base station 120, implement each layer as an entity for communication with another device using the protocols defined for the layer. For example, the user equipment 110 uses a Packet Data Convergence Protocol (PDCP) entity to communicate to a peer PDCP entity in a base station 120 using the PDCP.

The shared lower layers include a physical (PHY) layer 506, a Media Access Control (MAC) layer 508, a Radio Link Control (RLC) layer 510, and a PDCP layer 512. The PHY layer 506 provides hardware specifications for devices that communicate with each other. As such, the PHY layer 506 establishes how devices connect to each other, assists in managing how communication resources are shared among devices, and the like.

The MAC layer 508 specifies how data is transferred between devices. Generally, the MAC layer 508 provides a way in which data packets being transmitted are encoded and decoded into bits as part of a transmission protocol.

The RLC layer 510 provides data transfer services to higher layers in the network stack 500. Generally, the RLC layer 510 provides error correction, packet segmentation and reassembly, and management of data transfers in various modes, such as acknowledged, unacknowledged, or transparent modes.

The PDCP layer 512 provides data transfer services to higher layers in the network stack 500. Generally, the PDCP layer 512 provides transfer of user plane 502 and control plane 504 data, header compression, ciphering, and integrity protection.

Above the PDCP layer 512, the network stack 500 splits into the user-plane 502 and the control-plane 504. Layers of the user plane 502 include an optional Service Data Adaptation Protocol (SDAP) layer 514, an Internet Protocol (IP) layer 516, a Transmission Control Protocol/User Datagram Protocol (TCP/UDP) layer 518, and an application layer 520, which transfers data using the wireless link 130. The optional SDAP layer 514 is present in 5G NR networks. The SDAP layer 514 maps a quality-of-service flow for each data radio bearer and marks quality-of-service flow identifiers in uplink and downlink data packets for each packet data session. The IP layer 516 specifies how the data from the application layer 520 is transferred to a destination node. The TCP/UDP layer 518 is used to verify that data packets intended to be transferred to the destination node reached the destination node, using either TCP or UDP for data transfers by the application layer 520. In some implementations, the user plane 502 may also include a data services layer (not shown) that provides data transport services to transport application data, such as IP packets including web-browsing content, video content, image content, audio content, or social media content.

The control plane 504 includes a Radio Resource Control (RRC) layer 524 and a Non-Access Stratum (NAS) layer 526. The RRC layer 524 establishes and releases connections and radio bearers, broadcasts system information, or performs power control. The RRC layer 524 also controls a resource control state of the user equipment 110 and causes the user equipment 110 to perform operations according to the resource control state. Example resource control states include a connected state (e.g., an RRC connected state) or a disconnected state, such as an inactive state (e.g., an RRC inactive state) or an idle state (e.g., an RRC idle state). In general, if the user equipment 110 is in the connected state, the connection with the base station 120 is active. In the inactive state, the connection with the base station 120 is suspended. If the user equipment 110 is in the idle state, the connection with the base station 120 is released. Generally, the RRC layer 524 supports 3GPP access but does not support non-3GPP access (e.g., WLAN communications).

The NAS layer 526 provides support for mobility management (e.g., using a 5th-Generation Mobility Management (5GMM) layer 528) and packet data bearer contexts (e.g., using a 5th-Generation Session Management (5GSM) layer 530) between the user equipment 110 and entities or functions in the core network 150. The NAS layer 526 supports both 3GPP access and non-3GPP access.

In the user equipment 110, each layer in both the user plane 502 and the control plane 504 of the network stack 500 interacts with a corresponding peer layer or entity in the base station 120, a core network entity or function, and/or a remote service, to support user applications and control operation of the user equipment 110 in the RAN 140.

### Control Signaling for Monostatic Radar Sensing

FIG. 6 illustrates an example transaction diagram 600 between the base station 120 and the user equipment 110 to implement aspects of control signaling for monostatic radar sensing. At 605, the user equipment 110 transmits a radar capability message 606 (e.g., a UERadarCapabilityInformation message) to the base station 120. In some implementations, information elements of the radar capability message 606 can be incorporated into a UECapabilityInformation message.

The radar capability message 606 includes at least one available configuration of the user equipment 110 for monostatic radar sensing (e.g., a possible configuration 418 of the user equipment 110). The available configuration represents an operational configuration of the user equipment 110 for generating the radar signal 310, transmitting the radar signal 310, receiving the reflected radar signal 330, processing the reflected radar signal 330, and/or transmitting the radar report message 340. In some cases, the available configuration specifies adjustable characteristics of the radar signal 310, such as a carrier frequency, a bandwidth, a radar waveform (e.g., a modulation type), and/or a transmit power level. The available configuration can also include a hardware configuration of the user equipment 110, a software configuration of the user equipment 110, radar-sensing-performance metrics of the user equipment 110, available resources of the user equipment 110, or some combination thereof.

An example hardware configuration includes an antenna configuration, such as a single antenna for transmission and reception, a phased array for transmission and/or reception, or MIMO operation. Another example hardware configuration includes a duplex configuration, such as a half-duplex configuration to implement a pulsed-Doppler radar or a full-duplex configuration to implement a frequency-modulated continuous-wave radar.

Example software configurations of the user equipment 110 include a radar-signal-processing configuration and/or a reporting configuration. The radar-signal-processing configuration specifies the signal-processing techniques the user equipment 110 can employ to determine explicit information about the object 180. Some radar-signal-processing configurations can be tailored to be less complex and utilize less memory. For example, a first radar-signal-processing configuration performs a Fourier transform (e.g., a fast Fourier transform (FFT)) and uses a detection threshold algorithm. With these techniques, the first radar-signal-processing configuration can detect the object 180 and measure a distance to the object 180. Other radar-signal-processing configurations can be more complex and utilize more memory in order to reduce false alarms and improve accuracy. For example, a second radar-signal-processing configuration can include a clutter tracker to monitor clutter, an object tracker to improve a likelihood of detecting the object 180 as well as improve measurement accuracy, and/or a digital beamformer to measure one or more angles to the object 180.

The reporting configuration specifies an operational configuration of the user equipment 110 for transmitting the radar report message 340 to the base station 120. For example, the reporting configuration can specify available frequency bands and/or antenna configurations. Additionally or alternatively, the reporting configuration can specify the type of information elements that can be included within the radar report message 340. Example information elements can be associated with the position information, the movement information, the size information, and/or the material composition information of the object 180 as determined by one or more radar-signal-processing configurations.

Additionally or alternatively, the available configuration can specify a range of radar-sensing-performance metrics of the user equipment 110. Example radar-sensing-performance metrics include a radar resolution capability of the user equipment 110 (e.g., a range resolution, a Doppler resolution, or an angular resolution) and/or a detection range capability of the user equipment 110. Also, the available configuration can specify current resources of the user equipment 110 that are available to support monostatic radar sensing. These resources can include an amount of power available for monostatic radar sensing (e.g., a battery level of the user equipment 110), an amount of memory available for monostatic radar sensing, and/or a processing capacity of the user equipment 110.

Optionally at 610, the user equipment 110 transmits a radar availability message 612 to the base station. The radar availability message 612 indicates whether or not the user equipment 110 is available to perform monostatic radar sensing. In some implementations, the user equipment 110 uses the radio resource control layer 524 to transmit the radar availability message 612 to the base station 120.

The availability of the user equipment 110 to perform monostatic radar sensing can be based on environmental or operating conditions. For example, the user equipment 110 can indicate that it is unavailable to perform monostatic radar sensing if thermal temperatures are outside a specified range (e.g., due to solar loading or winter conditions). Additionally or alternatively, the user equipment 110 can opt out of monostatic radar sensing if the user equipment 110's battery level, available memory, and/or processing capacity are below respective thresholds.

At 615, the base station 120 selects a configuration 418 of the user equipment 110 based on the radar capability message 606. In this way, the base station 120 can customize the configuration 418 of the user equipment 110 based on a variety of criteria, including available resources within the user equipment 110, a target radar-sensing-performance metric, a current operating environment, and/or available channel resources. For example, if the radar capability message 606 indicates that the available power, available memory, and/or processing capacity of the user equipment 110 is approaching a corresponding threshold, the base station 120 can select a configuration 418 that utilizes less power, less memory, and/or less processing capacity.

In some situations, the base station 120 selects the configuration 418 based on a target radar-sensing-performance metric (e.g., a target resolution or a target detection range). If the base station 120 previously received information about the object 180, the base station 120 can select a configuration 418 that increases a resolution of the user equipment 110 to improve the accuracy of subsequent information about the object 180. In other situations, the base station 120 selects the configuration 418 based on a determined distance between the object 180 and the user equipment 110. For example, the selected configuration 418 can specify a transmit power level that enables the user equipment 110 to detect the object 180 within a specified distance.

The base station 120 can also select the configuration 418 based on the proximity of other user equipment to the user equipment 110. In this case, the base station 120 can control the transmit power level of the user equipment 110 to manage interference at the other user equipment. If the other user equipment are proximate to the user equipment 110, the base station 120 can reduce the transmit power level of the user equipment 110 to reduce the interference at the other user equipment. Alternatively, if the other user equipment are sufficiently far away from the user equipment 110, the base station 120 can increase the transmit power level of the user equipment 110 to increase the detection range of the user equipment 110 for monostatic radar sensing. By increasing the detection range, the user equipment 110 can detect additional objects 180.

Additionally or alternatively, the base station 120 can select the configuration 418 to control characteristics of the radar signal 310, such as the carrier frequency, the bandwidth, and/or the radar waveform. The base station 120 can also select the configuration 418 to cause the user equipment 110 to provide certain information within the radar report message 340. For example, the base station 120 can select the configuration 418 to include a particular reporting configuration that includes position information, movement information, size information, and/or material composition information within the radar report message 340.

At 620, the base station 120 transmits a radar configuration message 622 (e.g., a RadarMeasurementConfiguration message) to the user equipment 110. In general, the radar configuration message 622 is similar to a MeasurementConfiguration message, except the information elements within the radar configuration message 622 are associated with monostatic radar sensing instead of wireless communication. The radar configuration message 622 directs the user equipment 110 to use the configuration 418 selected at 615 for monostatic radar sensing. In some implementations, the base station 120 uses the physical downlink control channel (PDCCH) to send at least a portion of the radar configuration message 622 to the user equipment 110. Sometimes, the base station 120 sends information contained within the radar configuration message 622 along with other physical downlink control channel information, such as downlink control information (DCI) and/or uplink control information (UCI). For example, the base station 120 can specify a waveform of the radar signal 310 and a waveform for communicating uplink data for a particular frequency band using a same control message.

Sometimes the base station 120 uses the radar configuration message 622 to specify a timing of the radar report message 340. For example, the base station 120 can direct the user equipment 110 to transmit the radar report message 340 responsive to the user equipment 110 detecting one or more objects 180. In this way, the user equipment 110 does not transmit the radar report message 340 until it detects the object 180. In other examples, the base station 120 directs the user equipment 110 to transmit the radar report message 340 at periodic time intervals. A transmission period of the radar report messages 340 can be different than a transmission period associated the radar request message 302. For example, the user equipment 110 can transmit multiple radar report messages 340 responsive to receiving one radar request message 302 from the base station 120.

The base station 120 can also use the radar configuration message 622 to direct the user equipment 110 to use certain timing and/or frequency resources for monostatic radar sensing. In a first example, the base station 120 uses the radar configuration message 622 to direct the user equipment 110 to use a frequency band associated with wireless communication for transmitting the radar signal 310. In some cases, the frequency band can be associated with millimeter or sub-millimeter wavelengths. The base station 120 can also allocate larger quantities of radio bearers to enable the user equipment 110 to utilize larger bandwidths, thereby improving the range resolution of the user equipment 110.

In regards to timing resources, the base station 120 can use the radar configuration message 622 to direct the user equipment 110 to use different uplink timing than the physical uplink shared channel (PUSCH) for monostatic radar sensing. For example, the base station 120 can direct the user equipment 110 to use a downlink portion of a time-division-duplexing (TDD) frame. In general, the base station 120 can direct the user equipment 110 to use similar or different uplink resources than those used for communicating uplink data.

In some situations, the base station 120 uses the radar configuration message 622 to direct the user equipment 110 to use a wireless reference signal for monostatic radar sensing. Example wireless reference signals include a sounding reference signal (SRS) (e.g., an aperiodic SRS) or a demodulation reference signal (DM-RS). Other example wireless signals that can be used for monostatic radar sensing include signals sent using the physical uplink control channel (PUCCH) (e.g., a channel-state-information (CSI) signal) or the physical uplink shared channel. In general, any type of reference signal for wireless communication can be used if the reference signal has sufficient auto-correlation statistics for monostatic radar sensing. In some cases, the base station 120 further customizes characteristics of the wireless signal for monostatic radar sensing. For example, the base station 120 can specify a modulation type of a reference signal to enable the user equipment 110 to measure a Doppler frequency associated with the object 180.

By directing the user equipment 110 to use a wireless communication signal for monostatic radar sensing, the base station 120 enables efficient utilization of timing and frequency resources. For example, the base station 120 can use the transmitted reference signal for channel estimation while the user equipment 110 receives a reflected version of the transmitted reference signal for monostatic radar sensing. In this manner, the base station 120 enables concurrent wireless communication and monostatic radar sensing to occur. Additionally, by using the same frequency resources, the monostatic radar sensing can provide explicit information about a transmission channel to better enable the base station 120 to improve wireless communication performance.

At 625, the base station 120 transmits the radar request message 302 to the user equipment 110. The radar request message 302 requests that the user equipment 110 performs monostatic radar sensing. The base station 120 can use the physical downlink control channel or the media access control layer 508 to send the radar request message 626 to the user equipment 110. In this way, the radar request message 302 can represent a physical downlink control channel message or a media access control message. As an example, the base station 120 can use downlink control information (DCI) of the physical downlink control channel to carry information associated with the radar request message 626 to the user equipment 110. If the user equipment 110 transmits the radar availability message 612, the base station 120 transmits the radar request message 626 responsive to the radar availability message 612 indicating that the user equipment 110 is available to perform monostatic radar sensing.

In some cases, the base station 120 transmits the radar request message 302 to a group of user equipment 110 based on the received radar capability messages 606. For example, the base station 120 can select multiple user equipment 110 that can realize a target radar resolution, detect objects 180 within a particular region (e.g., based on detection range capabilities and antenna configurations), and/or perform beamforming to directly measure an angular position of the object 180.

At 630, the user equipment 110 performs monostatic radar sensing 630 responsive to receiving the radar request message 626. For example, the user equipment 110 transmits the radar signal 310 and receives the reflected radar signal 330, as shown in FIG. 3. The user equipment 110 performs the monostatic radar sensing according to the configuration 418 specified by the base station 120. By performing monostatic radar sensing, the user equipment 110 determines explicit information (e.g., position information, movement information, size information, or material composition information) about the object 180.

At 635, the user equipment 110 transmits a radar report message 340 to the base station 120. The radar report message 340 includes the information about the object 180. The base station 120 can use the radar report message 340 to improve wireless communication performance. For example, the base station 120 can use the information about the object 180 to generate a map of the environment and model the propagation paths 220. In some cases, the base station 120 compiles information from multiple user equipment 110. Based on the modeled propagation paths 220, the base station 120 can adjust beamforming configurations to improve wireless communication performance (e.g., improve signal-to-noise ratios).

### Example Methods

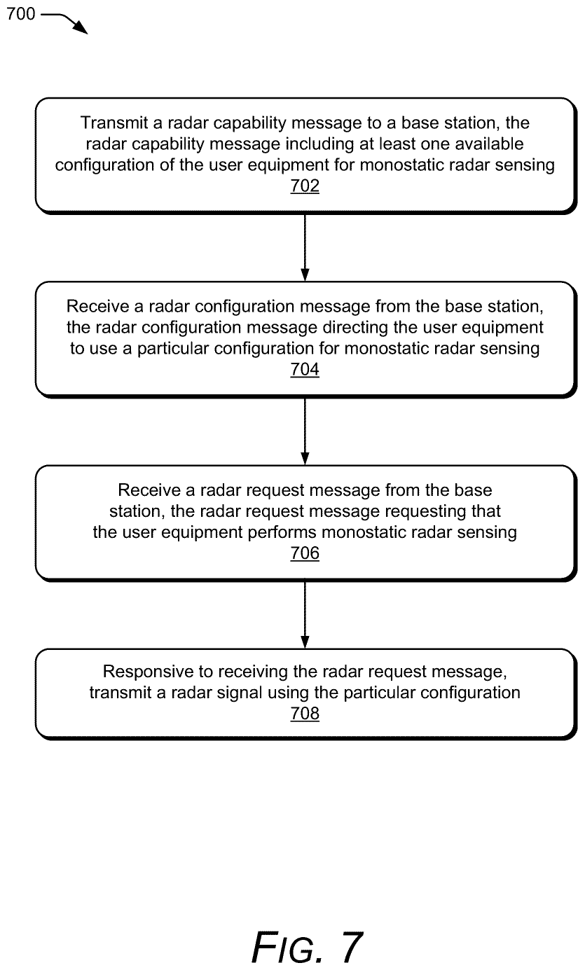

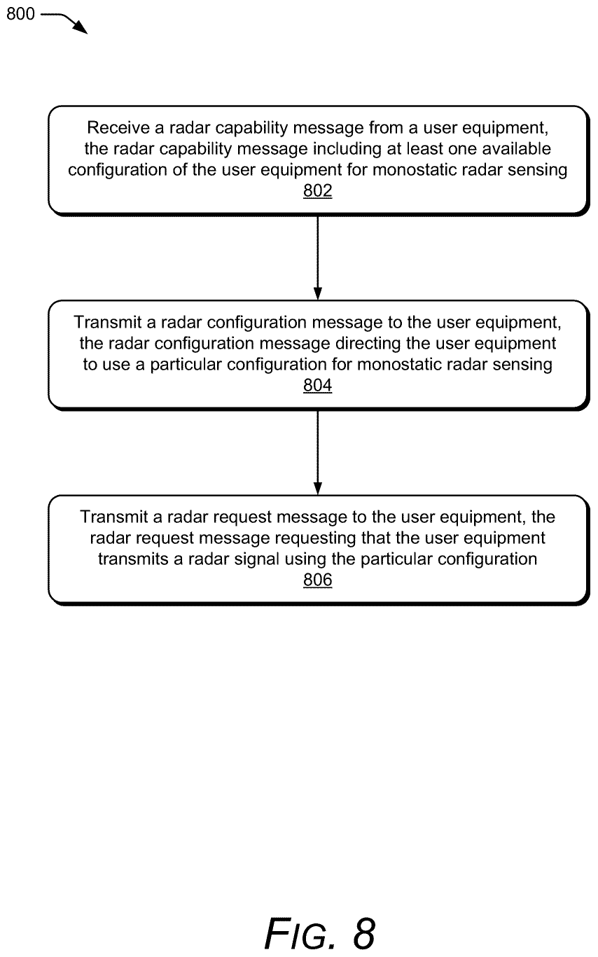

FIGS. 7 and 8 depict example methods 700 and 800 for performing operations of control signaling for monostatic radar sensing. In portions of the following discussion, reference may be made to the environments 200 and 300 of FIGS. 2 and 3, and entities detailed in FIG. 1 or 4, reference to which is made for example only. The techniques are not limited to performance by one entity or multiple entities operating on one device.

At 702 in FIG. 7, the user equipment transmits a radar capability message to a base station. The radar capability message includes at least one available configuration of the user equipment for monostatic radar sensing. For example, the user equipment 110 transmits the radar capability message 606 to the base station 120, as shown at 605 in FIG. 6. The radar capability message 606 includes at least one available configuration (e.g., at least one possible configuration 418) of the user equipment 110 for monostatic radar sensing. The available configuration can specify an operational configuration of the user equipment 110 for generating the radar signal 310, transmitting the radar signal 310, receiving the reflected radar signal 330, processing the reflected radar signal 330, and/or transmitting the radar report message 340. In particular, the available configuration can specify characteristics of the radar signal 310, a hardware configuration of the user equipment 110, a software configuration of the user equipment 110, a radar-sensing-performance metric of the user equipment 110, available resources of the user equipment 110, or some combination thereof.

At 704, the user equipment receives a radar configuration message from the base station. The radar configuration message directs the user equipment to use a particular configuration for monostatic radar sensing. For example, the user equipment 110 receives the radar configuration message 622 from the base station, as shown at 620 in FIG. 6. The radar configuration message 622 directs the user equipment 110 to use a particular configuration selected by the base station 120. The radar configuration message 622 can also specify timing and/or frequency resources for monostatic radar sensing. In some cases, the radar configuration message 622 enables the user equipment 110 to perform concurrent monostatic radar sensing and wireless communication.

At 706, the user equipment receives a radar request message from the base station. The radar request message requests that the user equipment performs monostatic radar sensing. For example, the user equipment 110 receives the radar request message 302 from the base station 120, as shown at 625 in FIG. 6. The radar request message 302 requests that the user equipment 110 performs monostatic radar sensing (e.g., instructs the user equipment 110 to transmit the radar signal 310).

At 708, the user equipment transmits a radar signal using the particular configuration responsive to receiving the radar request message. For example, the user equipment 110 transmits the radar signal 310 using the particular configuration responsive to receiving the radar request message 302, as shown in FIG. 3.

At 802 in FIG. 8, the base station receives a radar capability message from a user equipment. The radar capability message includes at least one available configuration of the user equipment for monostatic radar sensing. For example, the base station 120 receives the radar capability message 606 from the user equipment 110, as shown at 610 in FIG. 6. The radar capability message 606 includes at least one available configuration of the user equipment 110 for monostatic radar sensing.

The base station 120 can select a particular configuration of the user equipment 110 based on the radar capability message 606, as shown at 615 in FIG. 6. The base station 120 can customize the configuration based on a variety of criteria, including available resources within the user equipment 110, a target-radar-sensing metric, a current operating environment, and/or available channel resources.

At 804, the base station transmits a radar configuration message to the user equipment. The radar configuration message directs the user equipment to use a particular configuration for monostatic radar sensing. For example, the base station 120 transmits the radar configuration message 622 to the user equipment 110, as shown at 620 in FIG. 6. The radar configuration message 622 directs the user equipment 110 to use the particular configuration (e.g., the configuration 418 selected at 615 in FIG. 6) for monostatic radar sensing.

At 806, the base station transmits a radar request message to the user equipment. The radar request message requests that the user equipment transmits the radar signal using the particular configuration. For example, the base station 120 transmits the radar request message 302 to the user equipment 110, as shown in FIGS. 3 and 6. The radar request message 302 requests that the user equipment 110 transmits the radar signal 310 using the particular configuration.

Methods 700 and 800 are shown as sets of operations (or acts) performed but not necessarily limited to the order or combinations in which the operations are shown herein. Further, any of one or more of the operations may be repeated, combined, reorganized, skipped, or linked to provide a wide array of additional and/or alternate methods.

### CONCLUSION

Although techniques using, and apparatuses including, control signaling for monostatic radar sensing have been described in language specific to features and/or methods, it is to be understood that the subject of the appended claims is not necessarily limited to the specific features or methods described. Rather, the specific features and methods are disclosed as example implementations of control signaling for monostatic radar sensing.

Some examples are described below.

Example 1: A method performed by a user equipment, the method comprising: transmitting a radar capability message to a base station, the radar capability message comprising at least one available configuration of the user equipment for monostatic radar sensing:
receiving a radar configuration message from the base station, the radar configuration message directing the user equipment to use a particular configuration for monostatic radar sensing;
receiving a radar request message from the base station, the radar request message requesting that the user equipment performs monostatic radar sensing: and responsive to receiving the radar request message, transmitting a radar signal using the particular configuration.

Example 2: The method of example 1, wherein the available configuration of the user equipment comprises a range of radar-sensing-performance metrics of the user equipment including at least one of the following:
at least one radar resolution capability of the user equipment;
at least one detection range capability of the user equipment;
an amount of power available for monostatic radar sensing;
an amount of memory available for monostatic radar sensing; or processing capacity available for monostatic radar sensing.

Example 3: The method of any previous example, further comprising:
transmitting a radar report message to the base station, the radar report message including information about whether an object was detected. For example, the method may include receiving a reflected version of the radar signal, the radar signal reflected off an object and determining, based on the reflected version of the radar signal, information about the object. Similarly, the method may include determining that no object is present (at all or in a particular area of interest). For example, it may be determined that no object is present if a reflected version of the radar signal is not received from any object (e.g. at all or in the particular area of interest).

Example 4: The method of any preceding example, wherein the available configuration of the user equipment comprises at least one of the following:
a configuration of the user equipment for generating the radar signal specifying at least one radar waveform;
a configuration of the user equipment for transmitting and receiving the radar signal including at least one duplex configuration of the user equipment;
a configuration of the user equipment for processing the reflected radar signal including:
   a first radar-signal-processing configuration utilizing a first amount of memory, and
   a second radar-signal-processing configuration utilizing a second amount of memory that is different than the first amount of memory; or
a configuration of the user equipment for transmitting a radar report message.

Example 5: The method of example 4, wherein the configuration of the user equipment for transmitting the radar report message comprises at least one of the following:
at least one second frequency band;
at least one second antenna configuration; or
available information elements associated with the radar report message.

Example 6: The method of any previous example, wherein:
the radar configuration message directs the user equipment to use a reference signal for monostatic radar sensing: and
the transmitting of the radar signal comprises transmitting the reference signal as the radar signal.

Example 7: The method of example 6, wherein:
the reference signal comprises a sounding reference signal (SRS) or a demodulation reference signal (DM-RS).

Example 8: A method performed by a base station, the method comprising:
receiving a radar capability message from a user equipment, the radar capability message including at least one available configuration of the user equipment for monostatic radar sensing;
transmitting a radar configuration message to the user equipment, the radar configuration message directing the user equipment to use the particular configuration for monostatic radar sensing: and
transmitting a radar request message to the user equipment, the radar request message requesting that the user equipment transmits a radar signal using the particular configuration.

Example 9: The method of example 8, further comprising:
selecting a particular configuration of the user equipment based on the radar capability message.

Example 10: The method of example 8 or 9, further comprising receiving a radar report message from the user equipment, the radar report message including information about an object detected by the user equipment using monostatic radar sensing:
modeling propagation paths within an operating environment based on the information about the object; and
adjusting beamforming configurations associated with wireless communication based on the modeled propagation paths.

Example 11: The method of example 8, 9 or 10, further comprising:
receiving a radar availability message from the user equipment, the radar availability message indicating whether or not the user equipment is available to perform monostatic radar sensing,
wherein the transmitting of the radar request message comprises transmitting the radar request message responsive to the radar availability message indicating that the user equipment is available to perform monostatic radar sensing.

Example 12: The method of any one of examples 9 to 11, wherein:
the radar capability message comprises available resources within the user equipment; and
the method further comprises selecting the particular configuration of the user equipment based on the available resources within the user equipment.

Example 13: The method of any one of examples 9 to 12, wherein:
the radar capability message comprises at least one radar-sensing-performance metric of the user equipment: and
the method further comprises selecting the particular configuration of the user equipment based on the at least one radar-sensing-performance metric of the user equipment.

Example 14: The method of any one of examples 8 to 13, wherein the radar configuration message comprises at least one of the following:
a timing resource;
a frequency resource;
a radar waveform;
an antenna configuration;
a duplex configuration;
a transmit power level;
a radar-signal-processing configuration; or
a reporting configuration.

Example 15: The method of any one of examples 8 to 14, wherein the radar request message comprises a physical downlink control channel (PDCCH) message or a media access control (MAC) message.

Example 16: An apparatus comprising:
at least one antenna;
at least one transceiver;
at least one processor; and
at least one computer-readable storage media comprising instructions, responsive to execution by the processor, for directing the apparatus to perform any one of the methods of examples 1 to 7 or 8 to 15.

Example 17: A computer-readable storage media comprising instructions that, responsive to execution by a processor, cause an apparatus comprising the processor to perform any one of the methods of examples 1 to 7 or 8 to 15.

1. A method performed by a user equipment, the method comprising:
transmitting a radar capability message to a base station, the radar capability message comprising a plurality of parameters of the user equipment for monostatic radar sensing;
receiving a radar configuration message from the base station, the radar configuration message directing the user equipment to use a particular configuration for monostatic radar sensing, the particular configuration being based on at least one of the plurality of parameters;
receiving a radar request message from the base station, the radar request message requesting that the user equipment performs monostatic radar sensing; and
responsive to receiving the radar request message, transmitting a radar signal using the particular configuration.

2. The method of claim 1, wherein the plurality of parameters of the user equipment comprises a range of radar-sensing-performance metrics of the user equipment including at least one of the following:
at least one radar resolution capability of the user equipment;
at least one detection range capability of the user equipment;
an amount of power available for monostatic radar sensing;
an amount of memory available for monostatic radar sensing; or
processing capacity available for monostatic radar sensing.

3. The method of any previous claim 1, further comprising:
receiving a reflected version of the radar signal, the radar signal reflected off an object;
determining, based on the reflected version of the radar signal, information about the object; and
transmitting a radar report message to the base station, the radar report message including the information about the object.

4. The method of claim 3, wherein the plurality of parameters comprises at least one of the following:
a parameter of the user equipment for generating the radar signal specifying at least one radar waveform;
a parameter of the user equipment for transmitting and receiving the radar signal including at least one duplex setting of the user equipment;
a parameter of the user equipment for processing the reflected radar signal including:
a first radar-signal-processing parameter associated with a first amount of memory, and
a second radar-signal-processing parameter associated with a second amount of memory that is different than the first amount of memory; or
a parameter of the user equipment for transmitting a radar report message.

5. The method of claim 4, wherein the parameter of the user equipment for transmitting the radar report message comprises at least one of the following:
at least one second frequency band;
at least one second antenna parameter; or
available information elements associated with the radar report message.

6. The method of claim 1, wherein:
the radar configuration message directs the user equipment to use a reference signal for monostatic radar sensing; and
the transmitting of the radar signal comprises transmitting the reference signal as the radar signal.

7. The method of claim 6, wherein:
the reference signal comprises a sounding reference signal (SRS) or a demodulation reference signal (DM-RS).

8. A method performed by a base station, the method comprising:
receiving a radar capability message from a user equipment, the radar capability message including a plurality of parameters of the user equipment for monostatic radar sensing;
transmitting a radar configuration message to the user equipment, the radar configuration message directing the user equipment to use a particular configuration for monostatic radar sensing, the particular configuration being based on at least one of the plurality of parameters; and
transmitting a radar request message to the user equipment, the radar request message requesting that the user equipment transmits a radar signal using the particular configuration.

9. The method of claim 8, further comprising:
selecting the particular configuration of the user equipment based on the radar capability message;
receiving a radar report message from the user equipment, the radar report message including information about an object detected by the user equipment using monostatic radar sensing;
modeling propagation paths within an operating environment based on the information about the object; and
adjusting beamforming configurations associated with wireless communication based on the modeled propagation paths.

10. The method of claim 8, further comprising:
receiving a radar availability message from the user equipment, the radar availability message indicating whether or not the user equipment is available to perform monostatic radar sensing,
wherein the transmitting of the radar request message comprises transmitting the radar request message responsive to the radar availability message indicating that the user equipment is available to perform monostatic radar sensing.

11. The method of claim 9, wherein:
the radar capability message comprises available resources within the user equipment; and
the method further comprises selecting the particular configuration of the user equipment based on the available resources within the user equipment.

12. The method of claim 9, wherein:
the radar capability message comprises at least one radar-sensing-performance metric of the user equipment; and
the method further comprises selecting the particular configuration of the user equipment based on the at least one radar-sensing-performance metric of the user equipment.

13. The method of claim 8, wherein the radar configuration message comprises at least one of the following:
a timing resource;
a frequency resource;
a radar waveform;
an antenna configuration;
a duplex configuration;
a transmit power level;
a radar-signal-processing configuration; or
a reporting configuration.

14. The method of claim 8, wherein the radar request message comprises a physical downlink control channel (PDCCH) message or a media access control (MAC) message.

15. (canceled)

16. A computer-readable storage media comprising instructions that, responsive to execution by a processor, cause a user equipment to:
transmit a radar capability message to a base station, the radar capability message comprising a plurality of parameters of the user equipment for monostatic radar sensing;
receive a radar configuration message from the base station, the radar configuration message directing the user equipment to use a particular configuration for monostatic radar sensing, the particular configuration being based on at least one of the plurality of parameters;
receive a radar request message from the base station, the radar request message requesting that the user equipment performs monostatic radar sensing; and
responsive to receiving the radar request message, transmit a radar signal using the particular configuration.

17. The computer-readable storage media of claim 16, wherein the plurality of parameters of the user equipment comprises radar-sensing-performance metrics of the user equipment including at least one of the following:
at least one radar resolution capability of the user equipment;
at least one detection range capability of the user equipment;
an amount of power available for monostatic radar sensing;
an amount of memory available for monostatic radar sensing; or
processing capacity available for monostatic radar sensing.

18. The computer-readable storage media of claim 16, wherein the instructions, responsive to execution by the processor, cause the user equipment to:
receive a reflected version of the radar signal, the radar signal reflected off an object;
determine, based on the reflected version of the radar signal, information about the object; and
transmit a radar report message to the base station, the radar report message including the information about the object.

19. The computer-readable storage media of claim 18, wherein the plurality of parameters comprises at least one of the following:
a parameter of the user equipment for generating the radar signal specifying at least one radar waveform;
a parameter of the user equipment for transmitting and receiving the radar signal including at least one duplex configuration of the user equipment;
a parameter of the user equipment for processing the reflected radar signal including:
a first radar-signal-processing parameter associated with a first amount of memory, and
a second radar-signal-processing parameter associated with a second amount of memory that is different than the first amount of memory; or
a parameter of the user equipment for transmitting a radar report message.

20. The computer-readable storage media of claim 19, wherein the parameter of the user equipment for transmitting the radar report message comprises at least one of the following:
at least one second frequency band;
at least one second antenna parameter; or
available information elements associated with the radar report message.

21. The computer-readable storage media of claim 16, wherein:
the radar configuration message directs the user equipment to use a reference signal for monostatic radar sensing; and
the instructions, responsive to execution by the processor, cause the user equipment to transmit the reference signal as the radar signal.
